(19) United States
(12) Patent Application Publication
(10) Pub. No.: US 2014/0317402 A1
(43) Pub. Date: Oct. 23, 2014

(54) METHOD OF PROCESSING PACKET IN BELOW BINARY STACK STRUCTURE

(71) Applicant: ELECTRONICS AND TELECOMMUNICATIONS RESEARCH INSTITUTE, Daejeon (KR)

(72) Inventors: Seong MOON, Daejeon (KR); Ho Yong RYU, Daejeon (KR); Ho Sun YOON, Daejeon (KR)

(73) Assignee: ELECTRONICS AND TELECOMMUNICATIONS RESEARCH INSTITUTE, Daejeon (KR)

(21) Appl. No.: 14/050,566

(22) Filed: Oct. 10, 2013

(30) Foreign Application Priority Data
Apr. 18, 2013 (KR) 10-2013-0042970

(51) Int. Cl. H04L 29/06

(52) U.S. Cl. CPC H04L 63/0428
USPC 713/160

(57) ABSTRACT

Disclosed is a packet processing method in a below binary stack (BBS) structure. A transmission packet processing method includes receiving a packet from a network layer, reassembling a packet for which a first fragmentation has been performed when the received packet is the packet for which the first fragmentation has been performed, encrypting the reassembled packet, performing a second fragmentation for the encrypted packet when the second fragmentation is necessary for the encrypted packet, adding a header to the packet for which the second fragmentation has been performed, and transmitting the packet with the header added thereto through a physical layer. Accordingly, an encryption function can be provided in the BBS structure.

### CLAIM FOR PRIORITY

This application claims priority to Korean Patent Application No. 10-2013-0042970 filed on Apr. 18, 2013 in the Korean Intellectual Property Office (KIPO), the entire contents of which are hereby incorporated by reference.

### BACKGROUND

1. Technical Field

Example embodiments of the present invention relate in general to technology for processing a packet, and more specifically, to a packet processing method for encrypting and decrypting a packet in a below binary stack (BBS) structure.

2. Related Art

In an Internet protocol (IP) network, a tunneling scheme that adds an IP head to data is used for providing terminal mobility. An unchanged permanent IP address is recorded in the original IP header, and an IP address of a visited network which a terminal is currently visiting is recorded in a newly added IP header for tunneling. Information (i.e., an address) of the added IP header for tunneling is changed each time the terminal visits another network, but information (i.e., an address) of the original IP header is not changed.

In such an environment, an encryption function in the BBS structure can be provided for providing a security function for information exchanged by a terminal. However, since the BBS operates separately from a transmission control protocol/IP (TCP/IP) stack, the order of fragmentation/reassembly and encryption/decryption of packets can be mismatched, and for this reason, communication using packets cannot be performed.

### SUMMARY

Accordingly, example embodiments of the present invention are provided to substantially obviate one or more problems due to limitations and disadvantages of the related art.

Example embodiments of the present invention provide a transmission packet processing method for matching a transmission packet encryption order through reassembly of a fragmented packet.

Example embodiments of the present invention also provide a reception packet processing method for matching a reception packet decryption order through reassembly of a fragmented packet.

In some example embodiments, a transmission packet processing method, which is performed in a packet processing apparatus, includes: receiving a packet from a network layer; when the received packet is a packet for which a first fragmentation has been performed, reassembling the packet for which the first fragmentation has been performed; encrypting the reassembled packet; when a second fragmentation is necessary for the encrypted packet, performing the second fragmentation for the encrypted packet; adding a header to the packet for which the second fragmentation has been performed; and transmitting the packet with the header added thereto through a physical layer.

The network layer may be an IP layer.

The reassembling of the packet may include: storing the packet, for which the first fragmentation has been performed, in a queue; and when all of packets for which first fragmentation has been performed are stored in the queue, reassembling the packets for which the first fragmentation has been performed.

The encrypting of the reassembled packet may include performing encryption using an Internet protocol security (IPSec).

The transmission packet processing method may further include: when the second fragmentation is not necessary for the encrypted packet, adding the header to the encrypted packet; and transmitting the packet with the header added thereto through a physical layer.

The adding of the header may include encapsulating the packet for which the second fragmentation has been performed, for tunneling.

The transmitting of the packet may include transmitting the packet with the header added thereto through a tunnel connected between networks.

The transmission packet processing method may further include: when the packet received from the network layer is not the packet for which the first fragmentation has been performed, encrypting the received packet; when the second fragmentation is necessary for the encrypted packet, performing the second fragmentation for the encrypted packet; adding the header to the packet for which the second fragmentation has been performed; and transmitting the packet with the header added thereto through the physical layer.

The encrypting of the received packet may include performing encryption using an IPSec.

In other example embodiments, a reception packet processing method, which is performed in a packet processing apparatus, includes: receiving a packet from a physical layer; removing a header of the received packet; when the packet from which the header has been removed is a packet for which a first fragmentation has been performed, reassembling the packet for which the first fragmentation has been performed; decrypting the reassembled packet; when a second fragmentation is necessary for the decrypted packet, performing the second fragmentation for the decrypted packet; and transmitting the packet, for which the second fragmentation has been performed, to a network layer.

The receiving of a packet may include receiving the packet through a tunnel connected between networks.

The removing of a header may include decapsulating the packet received through the tunnel.

The reassembling of the packet may include: storing the packet, for which the first fragmentation has been performed, in a queue; and when all of packets for which first fragmentation has been performed are stored in the queue, reassembling the packets for which the first fragmentation has been performed.

The decrypting of the reassembled packet may include performing decryption using an IPSec.

The reception packet processing method may include, when the second fragmentation is not necessary for the decrypted packet, transmitting the decrypted packet to the network layer.

The network layer may be an IP layer.

The reception packet processing method may further include: when the packet from which the header has been removed is not the packet for which the first fragmentation has been performed, encrypting the packet from which the header has been removed; when the second fragmentation is necessary for the decrypted packet, performing the second fragmentation for the decrypted packet; and transmitting the packet, for which the second fragmentation has been performed, to the network layer.

The decrypting of the packet from which the header has been removed may include performing decryption using an IPSec.

### BRIEF DESCRIPTION OF DRAWINGS

These and other objects, features and advantages of the present invention will become more apparent by describing in detail example embodiments of the present invention with reference to the accompanying drawings, in which:

FIG. 1 is a conceptual diagram illustrating a tunneling scheme for providing terminal mobility;

FIG. 2 is a block diagram illustrating an embodiment of a packet encapsulated by an IP tunneling scheme;

FIG. 3 is a block diagram illustrating another embodiment of a packet encapsulated by the IP tunneling scheme;

FIG. 4 is a block diagram illustrating an embodiment of a packet encapsulated by an IP-UDP tunneling scheme;

FIG. 5 is a block diagram illustrating another embodiment of a packet encapsulated by the IP-UDP tunneling scheme;

FIG. 6 is a block diagram illustrating a BITS scheme in an IPSec implementation scheme;

FIG. 7 is a block diagram illustrating a BBS scheme in the IPSec implementation scheme;

FIG. 8 is a conceptual diagram illustrating a packet processing operation in a BBS structure;

FIG. 9 is a flowchart illustrating a transmission packet processing method in the BBS structure according to an embodiment of the present invention;

FIG. 10 is a flowchart illustrating a reception packet processing method in the BBS structure according to an embodiment of the present invention; and

FIG. 11 is a block diagram illustrating a packet processing apparatus according to an embodiment of the present invention.

### DESCRIPTION OF EXAMPLE EMBODIMENTS

Since the present invention may have diverse modified embodiments, preferred embodiments are illustrated in the drawings and are described in the detailed description of the invention.

However, it should be understood that the particular embodiments are not intended to limit the present disclosure to specific forms, but rather the present disclosure is meant to cover all modification, similarities, and alternatives which are included in the spirit and scope of the present disclosure.

Relational terms such as first, second, and the like may be used for describing various elements, but the elements should not be limited by the terms. These terms are only used to distinguish one element from another. For example, a first element could be teamed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In the following description, the technical terms are used only for explaining a specific exemplary embodiment while not limiting the present disclosure. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art. Terms such as terms that are generally used and have been in dictionaries should be construed as having meanings matched with contextual meanings in the art. In this description, unless defined clearly, terms are not ideally, excessively construed as formal meanings.

Embodiments of the present invention will be described below in more detail with reference to the accompanying drawings. In describing the invention, to facilitate the entire understanding of the invention, like numbers refer to like elements throughout the description of the figures, and a repetitive description on the same element is not provided.

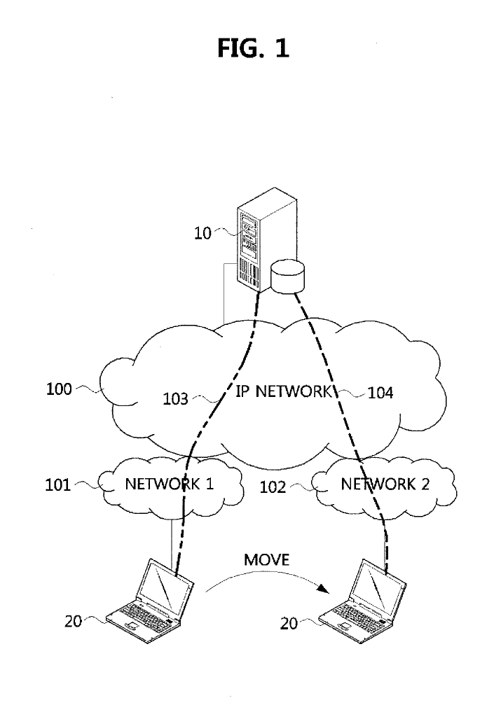

FIG. 1 is a conceptual diagram illustrating a tunneling scheme for providing terminal mobility.

In an IP network, most technologies for providing terminal mobility give a permanent address to a moving terminal to ensure transmission of a packet using the tunneling scheme.

In transmitting a packet through the tunneling scheme, a moving terminal always recognizes a permanent address, given to the terminal, as an address reachable on a network, and application programs of the terminal perform communication using the permanent address. A temporary address, which is an address that changes as the terminal moves to enter other IP networks, is used as a transmission means for carrying an IP packet.

That is, an application program using a permanent address tunnels a packet using information of an IP network which a terminal is currently visiting and IP network information of a correspondent node, for transferring a packet to the correspondent node over the IP network which the terminal is currently visiting.

Referring to FIG. 1, a terminal 20 accessing a network 1 (101) may use a tunnel 1 (103) for communicating with a correspondent node 10 over an IP network 100. The tunnel 1 (103) denotes a tunnel which is established based on information of the network 1 (101) currently accessed by the terminal 20 and information of the IP network 100 of the correspondent node 10.

When the terminal 20 accessing the network 1 (101) moves to access a network 2 (102), the terminal 20 accessing the network 2 (102) may use a tunnel 2 (104) for communicating with the correspondent node 10 over the IP network 100. The tunnel 2 (104) denotes a tunnel which is established based on information of the network 2 (102) currently accessed by the terminal 20 and the information of the IP network 100 of the correspondent node 10.

Here, the network may include, for example, a 2G mobile communication network such as Bluetooth, infrared communication, Global System for Mobile communication (GSM), and Code Division Multiple Access (CDMA), a mobile communication network for supporting wireless Internet such as Wireless Fidelity (WiFi) or WiFi direct, and portable Internet or packet transmission such as Wireless Broadband Internet (WiBro) or World Interoperability for Microwave Access (WiMax), a 3G mobile communication network such as a Wideband Code Division Multiple Access (WCDMA) or CDMA2000 network, a 3.5G mobile communication network such as a High Speed Downlink Packet Access (HSDPA) or High Speed Uplink Packet Access (HSUPA) network, and a 4G mobile communication network such as a Long Term Evolution (LTE) network or LTE-Advanced network.

Here, the terminal may include a communication-enabled desktop computer, laptop computer, tablet PC, wireless phone, mobile phone, smart phone, e-book reader, portable multimedia player, portable gaming console, navigation device, digital camera, digital multimedia broadcasting (DMB) player, digital audio recorder, digital audio player, digital picture recorder, digital picture player, digital video recorder, digital video player, etc.

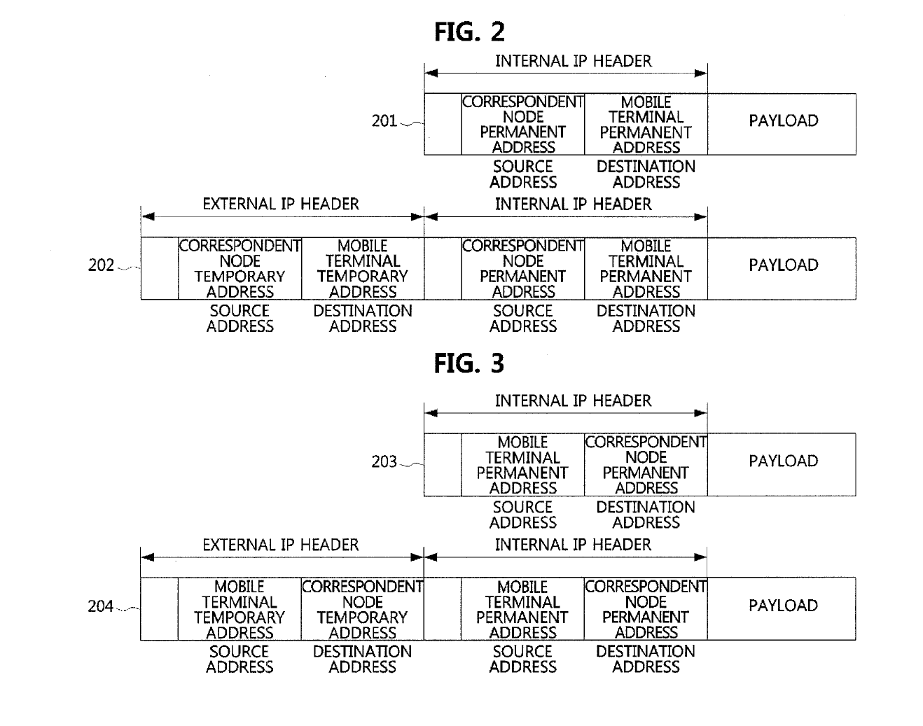

FIG. 2 is a block diagram illustrating an embodiment of a packet encapsulated by an IP tunneling scheme, and FIG. 3 is a block diagram illustrating another embodiment of a packet encapsulated by the IP tunneling scheme.

Referring to FIG. 2, when a correspondent node transmits a packet to a mobile terminal, the correspondent node may add an external IP header to an original packet 201, and transmit a packet 202 with the external IP header added thereto to the mobile terminal. That is, the correspondent node may transmit an encapsulated packet 202 to the mobile terminal.

Referring to FIG. 3, when a mobile terminal transmits a packet to a correspondent node, the mobile terminal may add an external IP header to an original packet 203, and transmit a packet 204 with the external IP header added thereto to the correspondent node. That is, the mobile terminal may transmit an encapsulated packet 204 to the correspondent node.

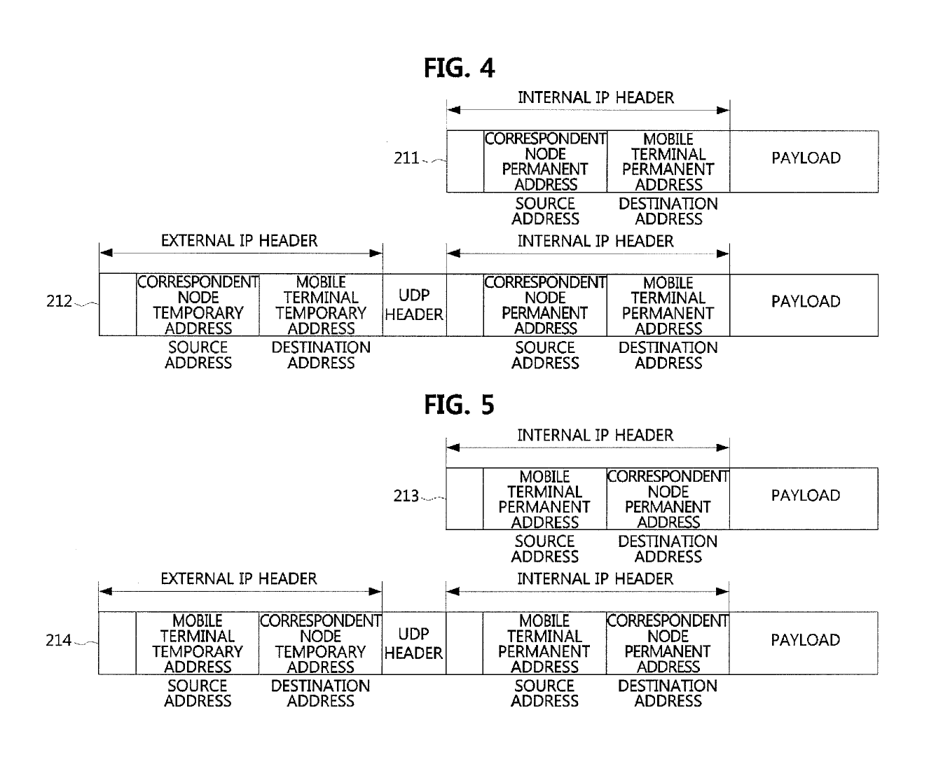

FIG. 4 is a block diagram illustrating an embodiment of a packet encapsulated by an IP-UDP tunneling scheme, and FIG. 5 is a block diagram illustrating another embodiment of a packet encapsulated by the IP-UDP tunneling scheme.

Referring to FIG. 4, when a correspondent node transmits a packet to a mobile terminal, the correspondent node may add an external IP header to an original packet 211, and transmit a packet 212 with the external IP header added thereto to the mobile terminal. That is, the correspondent node may transmit an encapsulated packet 212 to the mobile terminal.

Referring to FIG. 5, when a mobile terminal transmits a packet to a correspondent node, the mobile terminal may add an external IP header to an original packet 213, and transmit a packet 214 with the external IP header added thereto to the correspondent node. That is, the mobile terminal may transmit an encapsulated packet 214 to the correspondent node.

Herein, a permanent address denotes a permanent address of a correspondent node or a mobile terminal, and a temporary address denotes a temporary address of a correspondent node or a mobile terminal.

A packet structure of each of FIGS. 2 and 3 is a packet structure used in an IP over IP tunneling scheme, and a packet structure of each of FIGS. 4 and 5 is a packet structure used in an IP over IP-user datagram protocol (UDP) tunneling scheme.

The IP over IP tunneling scheme has a restriction when a network uses a network address translation (NAT) or when a firewall is established in the network. Therefore, when the network uses the NAT or when the firewall is established in the network, the IP over UDP tunneling scheme is used.

Thus, there is a requirement for data security even in an environment that provides terminal mobility using the tunneling scheme, in which case the data security may be provided through Internet protocol security (IPSec). The IPSec is used for providing functions, such as authentication of a data source, integrity, secrecy, prevention of a retransmission attack, etc., for an IP packet.

Am implementation scheme for applying the IPSec includes a bump in the stack (BITS) scheme and a below binary stack (BBS) scheme. The BITS scheme is a scheme that adds an IPSec function to a source of TCP/IP stack when it is possible to access a source code of the TCP/IP stack. On the other hand, the BBS scheme is a scheme that adds the IPSec function to a binary lower end of the TCP/IP stack when it is impossible to access the source code of the TCP/IP stack and it is possible to use only a binary of the TCP/IP stack.

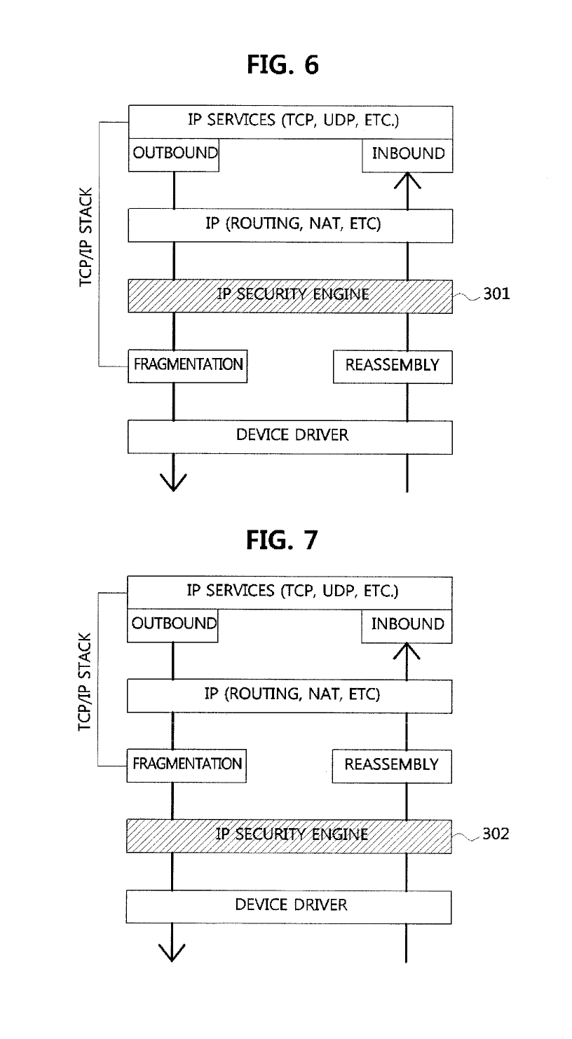

FIG. 6 is a block diagram illustrating the BITS scheme in the IPSec implementation scheme, and FIG. 7 is a block diagram illustrating the BBS scheme in the IPSec implementation scheme.

Referring to FIG. 6, in the BITS scheme, an IP security engine 301 that provides the IPSec function is provided inside the TCP/IP stack. That is, according to the BITS scheme, the IPSec function may be provided by the IP security engine 301 which is provided inside the TCP/IP stack.

Referring to FIG. 7, in the BBS scheme, an IP security engine 302 that provides the IPSec function is provided outside the TCP/IP stack. That is, according to the BBS scheme, the IPSec function may be provided by the IP security engine 302 which is provided outside the TCP/IP stack.

A processing order of fragmentation/reassembly of an IPSec and a packet is predetermined. That is, when transmitting a packet, IPSec encryption should be first performed for an IP packet, and the encrypted packet should be fragmented and transmitted. In receiving a packet, the fragmented packet is reassembled, and IPSec decryption should be performed for the reassembled packet.

However, in the BBS scheme, the IPSec and the TCP/IP stack operate separately, and thus, the order of fragmentation/reassembly of the IPSec and a packet is mismatched. That is, when transmitting a packet in the BBS scheme, IPSec encryption is performed for a fragmented packet, and when receiving a packet in the BBS scheme, IPSec decryption is performed for the fragmented packet.

Accordingly, in transmitting a packet, when the IPSec encryption is performed for a fragmented packet instead of for all packets, a receiving end directly performs the IPSec decryption without reassembling the packet, and thus, the decrypted packet is another fragmented packet, whereby the decrypted packet loses a destination. As a result, the decrypted packet is thrown away.

On the other hand, in receiving a packet, when the IPSec decryption is performed for the fragmented packet without reassembling the fragmented packet, encrypted information on all of the packets does not match decrypted information on the fragmented packet, and thus, the decryption of the packet fails.

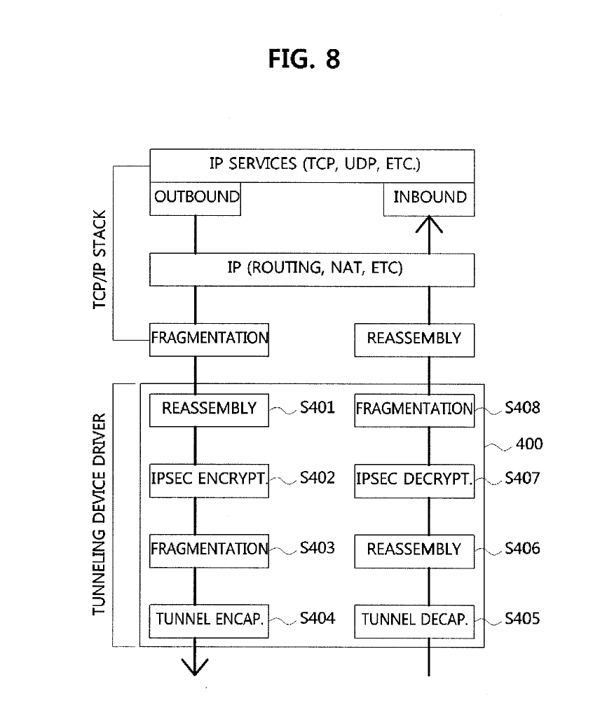

FIG. 8 is a conceptual diagram illustrating a packet processing operation in the BBS structure.

Referring to FIG. 8, the IPSec may be implemented as a tunneling device driver 400. In transmitting a packet, the packet may be reassembled in operation (reassembly) S401, IPSec encryption may be performed on the reassembled packet in operation (encrypt.) S402, the encrypted packet may be fragmented in operation (fragmentation) s403, and the fragmented packet may be encapsulated in operation (tunnel encap.) S404.

On the other hand, in receiving a packet, the packet may be decapsulated in operation (tunnel decap.) S405, the decapsulated packet may be reassembled in operation (reassembly) S406, IPSec decryption may be performed on the reassembled packet in operation (decrypt.) S407, and the decrypted packet may be fragmented in operation (fragmentation) S408.

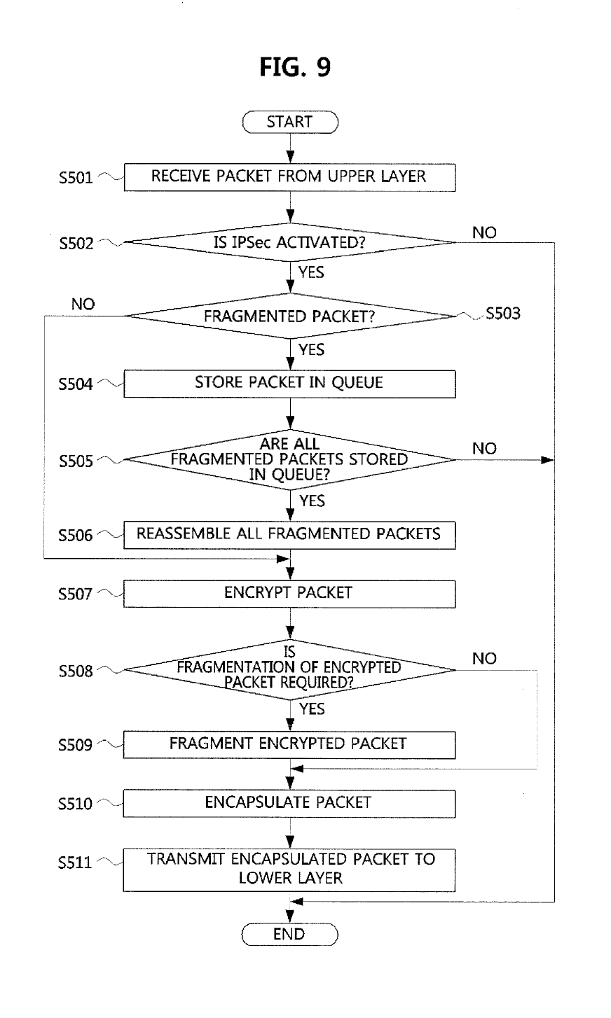

FIG. 9 is a flowchart illustrating a transmission packet processing method in the BBS structure according to an embodiment of the present invention.

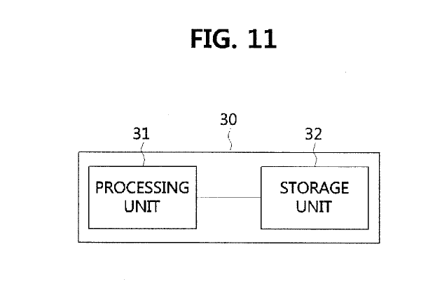

Operations of FIG. 9 may be performed by a packet processing apparatus of FIG. 11, which may denote a communicable terminal or a portion of the terminal capable of communication.

Referring to FIG. 9, the packet processing apparatus may receive a packet from an upper layer in operation S501. Here, the upper layer may denote a network layer in an open system interconnection (OSI) model, or an IP layer in a TCP/IP model.

Subsequently, the packet processing apparatus may determine whether the IPSec function is activated in operation S502. That is, when the IPSec function for the packet received from the upper layer is not activated, the packet processing apparatus may end processing of a transmission packet. However, when the IPSec function for the packet received from the upper layer is activated, the packet processing apparatus may determine whether the packet received from the upper layer corresponds to a fragmented packet in operation S503.

When the packet received from the upper layer corresponds to the fragmented packet, the packet processing apparatus may proceed to sequentially perform operations S504 to S507. On the other hand, when the packet received from the upper layer corresponds to a non-fragmented packet, the packet processing apparatus may proceed to perform operation S507. That is, the packet processing apparatus may not perform a reassembly operation for the non-fragmented packet.

When the packet received from the upper layer corresponds to the fragmented packet, the packet processing apparatus may store the packet received from the upper layer in a queue in operation S504, and determine whether all fragmented packets are stored in the queue in operation S505. That is, when all of the fragmented packets are not stored in the queue even after a predefined time (for example, a time when all of the fragmented packets are predicted to be transmitted) elapses, the packet processing apparatus may end processing of the transmission packet. However, when all fragmented packets are stored in the queue within the predefined time, the packet processing apparatus may reassemble the fragmented packet in operation S506.

Subsequently, the packet processing apparatus may encrypt a packet which has undergone the reassembly operation (i.e., a packet which has undergone operations S504 to S506), or a packet which has not undergone the reassembly operation (i.e., a packet which has not undergone operations S504 to S506), in operation S507. At this time, the packet processing apparatus may perform encryption using the IPSec. After the encryption is performed for the packet, the packet processing apparatus may determine whether it is required to fragment the encrypted packet in operation S508. When it is required to fragment the encrypted packet, the packet processing apparatus may proceed to sequentially perform operations S509 and S510. When it is not required to fragment the encrypted packet, the packet processing apparatus may proceed to perform operation S510. That is, the packet processing apparatus may not perform a fragmentation operation for the encrypted packet requiring no fragmentation.

When it is required to fragment the encrypted packet, the packet processing apparatus may fragment the encrypted packet in operation S509. Then, the packet processing apparatus may add a header to a packet which has undergone the fragmentation operation (i.e., a packet which has undergone operation S509) or a packet which has not undergone the fragmentation operation (i.e., a packet which has not undergone operation S509), in operation S510. That is, in operation S510, the packet processing apparatus may encapsulate the packet for tunneling.

Subsequently, the packet processing apparatus may transmit the packet with the header added thereto (i.e., the encapsulated packet) through a lower layer. Here, the lower layer may denote a physical layer or a tunnel connected between networks. That is, the packet processing apparatus may transmit the packet with the header added thereto through the tunnel connected between the networks.

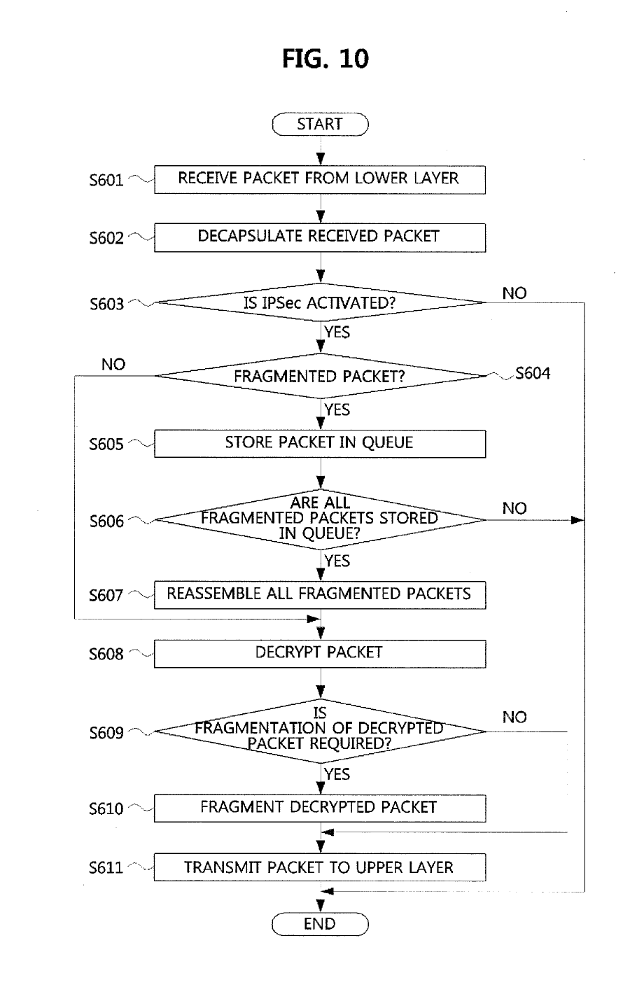

FIG. 10 is a flowchart illustrating a reception packet processing method in the BBS structure according to an embodiment of the present invention.

Operations of FIG. 10 may be performed by the packet processing apparatus of FIG. 11, which may denote a terminal capable of communication or a portion of the terminal capable of communication.

The packet processing apparatus may receive a packet from the lower layer in operation S601. Here, the lower layer may denote the physical layer or the tunnel connected between the networks. The packet processing apparatus may remove a header of the packet received from the lower layer in operation S602. That is, in operation S602, the packet processing apparatus may decapsulate the packet received through the tunnel.

Subsequently, the packet processing apparatus may determine whether the IPSec function is activated in operation S603. That is, when the IPSec function for the packet received from the lower layer is not activated, the packet processing apparatus may end processing of a reception packet. However, when the IPSec function for the packet received from the lower layer is activated, the packet processing apparatus may determine whether the packet received from the lower layer corresponds to a fragmented packet in operation S604.

When the packet received from the lower layer corresponds to the fragmented packet, the packet processing apparatus may proceed to sequentially perform operations S604 to S608. On the other hand, when the packet received from the lower layer corresponds to a non-fragmented packet, the packet processing apparatus may proceed to perform operation S608. That is, the packet processing apparatus may not perform a reassembly operation for the non-fragmented packet.

When the packet received from the lower layer corresponds to the fragmented packet, the packet processing apparatus may store the packet received from the lower layer in a queue in operation S605, and determine whether all fragmented packets are stored in the queue in operation S606. That is, when all of the fragmented packets are not stored in the queue even after a predefined time (for example, a time when all of the fragmented packets are predicted to be transmitted) elapses, the packet processing apparatus may end processing of the reception packet. However, when all fragmented packets are stored in the queue within the predefined time, the packet processing apparatus may reassemble the fragmented packet in operation S607.

Subsequently, the packet processing apparatus may encrypt a packet which has undergone the reassembly operation (i.e., a packet which has undergone operations S605 to S607) or a packet which has not undergone the reassembly operation (i.e., a packet which has not undergone operations S605 to S607), in operation S608. At this time, the packet processing apparatus may perform decryption using the IPSec. After the decryption is performed for the packet, the packet processing apparatus may determine whether it is required to fragment the decrypted packet in operation S609. When it is required to fragment the decrypted packet, the packet processing apparatus may proceed to sequentially perform operations S610 and S611. When it is not required to fragment the decrypted packet, the packet processing apparatus may proceed to perform operation S611. That is, the packet processing apparatus may not perform a fragmentation operation for the decrypted packet requiring no fragmentation.

When it is required to fragment the decrypted packet, the packet processing apparatus may fragment the decrypted packet in operation S610. Then, the packet processing apparatus may transmit a packet which has undergone the fragmentation operation (i.e., a packet which has undergone operation S610) or a packet which has not undergone the fragmentation operation (i.e., a packet which has not undergone operation S610), to the upper layer in operation S611. That is, the upper layer may denote the network layer in the OSI model or the IP layer in the TCP/IP model.

The transmission packet processing method and reception packet processing method according to the present invention may be implemented as program instructions executable by a variety of computers and recorded on a computer-readable medium. The computer-readable medium may include program instructions, a data file, a data structure, or a combination thereof. The program instructions recorded on the computer-readable medium may be designed and configured specifically for the present invention or can be publically known and available to those who are skilled in the field of software.

Examples of the computer-readable medium may include a hardware device such as ROM, RAM, and flash memory, which are specifically configured to store and execute program instructions. Examples of the program instructions can include machine codes made by, for example, a compiler, as well as high-level language codes executable by a computer, using an interpreter. The above exemplary hardware devices can be configured to operate as one or more software modules in order to operate in an exemplary embodiment, and the reverse is also possible.

FIG. 11 is a block diagram illustrating the packet processing apparatus according to an embodiment of the present invention.

Referring to FIG. 11, the packet processing apparatus 30 includes a processing unit 31 and a storage unit 32.

The packet processing apparatus 30 may denote the terminal capable of communication or a portion of the terminal capable of communication. The processing unit 31 may perform the above-described operations of FIG. 9 and the above-described operations of FIG. 10.

Specifically, in processing a transmission packet, the processing unit 31 may receive a packet from the network layer. Here, the network layer may denote the IP layer in the TCP/IP model. The processing unit 31 may encrypt the packet according to whether the IPSec function for the received packet is activated. That is, when the IPSec function for the received packet is activated, the processing unit 31 may encrypt the packet, but when the IPSec function for the received packet is not activated, the processing unit 31 may not encrypt the packet.

When the packet received from the network layer corresponds to a fragmented packet, the processing unit 31 may reassemble the fragmented packet. At this time, the processing unit 31 may store the packet received from the upper layer in the queue, and when all of the fragmented packets are stored in the queue, the processing unit 31 may reassemble the fragmented packet.

When the packet received from the network layer corresponds to a non-fragmented packet, the processing unit 31 may not perform a reassembly operation for the packet.

The processing unit 31 may encrypt a packet which has undergone the reassembly operation or a packet which has not undergone the reassembly operation, at which time the processing unit 31 may perform encryption using the IPSec. When it is required to additionally fragment the encrypted packet, the processing unit 31 may additionally fragment the encrypted packet. However, when it is not required to additionally fragment the encrypted packet, the processing unit 31 may not additionally fragment the encrypted packet.

The processing unit 31 may add a header to a packet which has been additionally fragmented or is not additionally fragmented, among encrypted packets. That is, the processing unit 31 may encapsulate the packet for tunneling. The processing unit 31 may transmit the packet with the header added thereto through the physical layer. Here, the physical layer may denote the tunnel connected between the networks.

Specifically, in processing a reception packet, the processing unit 31 may receive a packet from the physical layer. Here, the physical layer may denote the tunnel connected between the networks. The processing unit 31 may remove a header of the packet received from the physical layer. That is, the processing unit 31 may decapsulate the packet received through the tunnel.

The processing unit 31 may decrypt the packet according to whether the IPSec function for the received packet is activated. That is, when the IPSec function for the received packet is activated, the processing unit 31 may decrypt the packet, but when the IPSec function for the received packet is not activated, the processing unit 31 may not decrypt the packet.

When the packet from which the header has been removed corresponds to a fragmented packet, the processing unit 31 may reassemble the fragmented packet. At this time, the processing unit 31 may store the fragmented packet in the queue, and when all of the fragmented packets are stored in the queue, the processing unit 31 may reassemble the fragmented packet.

When the packet from which the header has been removed corresponds to a non-fragmented packet, the processing unit 31 may not perform the reassembly operation for the packet.

The processing unit 31 may decrypt a packet which has undergone the reassembly operation or a packet which has not undergone the reassembly operation, at which time the processing unit 31 may perform decryption using the IPSec. When it is required to additionally fragment the decrypted packet, the processing unit 31 may additionally fragment the decrypted packet. However, when it is not required to additionally fragment the decrypted packet, the processing unit 31 may not additionally fragment the decrypted packet.

The processing unit 31 may transmit the additionally fragmented packet, or the packet which is not additionally fragmented, to the network layer. Here, the network layer may denote the IP layer in the TCP/IP model.

Here, the processing unit 31 may include a processor and a memory. The processor may denote a general-purpose processor (for example, a central processing unit (CPU) and/or a graphics processing unit (GPU), etc.) or a special-purpose processor for performing the transmission packet processing method and/or reception packet processing method. The memory may store a program code for performing the transmission packet processing method and/or reception packet processing method. That is, the processor may read the program code stored in the memory and perform the operations of the transmission packet processing method and reception packet processing method on the basis of the read program code.

The storage unit 32 may store information to be processed by the processing unit 31 and information which has been processed by the processing unit 31. That is, the storage unit 32 may store a fragmented packet, a reassembled packet, an encrypted packet, a decrypted packet, an encapsulated packet, a decapsulated packet, etc.

According to the present invention, in transmitting a packet, an encryption order can be matched by adding an operation of reassembling a fragmented packet, and in receiving a packet, a decryption order can be matched by adding an operation of reassembling a fragmented packet.

In this way, an encryption/decryption order of a packet is matched by reassembling a fragmented packet, thus providing an encryption function in the BBS structure.

While example embodiments of the present invention and their advantages have been described in detail, it should be understood that various changes, substitutions and alterations may be made herein without departing from the scope of the invention as defined by the accompanying claims.

What is claimed is:

1. A transmission packet processing method, which is performed in a packet processing apparatus, comprising:
receiving a packet from a network layer;
when the received packet is a packet for which a first fragmentation has been performed, reassembling the packet for which the first fragmentation has been performed;
encrypting the reassembled packet;
when a second fragmentation is necessary for the encrypted packet, performing the second fragmentation for the encrypted packet;
adding a header to the packet for which the second fragmentation has been performed; and
transmitting the packet with the header added thereto through a physical layer.

2. The transmission packet processing method of claim 1, wherein the network layer is an IP layer.

3. The transmission packet processing method of claim 1, wherein the reassembling of the packet comprises:
storing the packet, for which the first fragmentation has been performed, in a queue; and
when all of packets for which first fragmentation has been performed are stored in the queue, reassembling the packets for which the first fragmentation has been performed.

4. The transmission packet processing method of claim 1, wherein the encrypting of the reassembled packet comprises performing encryption using an IPSec.

5. The transmission packet processing method of claim 1, further comprising:
when the second fragmentation is not necessary for the encrypted packet, adding the header to the encrypted packet; and
transmitting the packet with the header added thereto through a physical layer.

6. The transmission packet processing method of claim 1, wherein the adding of the header comprises encapsulating the packet for which the second fragmentation has been performed, for tunneling.

7. The transmission packet processing method of claim 1, wherein the transmitting of the packet comprises transmitting the packet with the header added thereto through a tunnel connected between networks.

8. The transmission packet processing method of claim 1, further comprising:
when the packet received from the network layer is not the packet for which the first fragmentation has been performed, encrypting the received packet;
when the second fragmentation is necessary for the encrypted packet, performing the second fragmentation for the encrypted packet;
adding the header to the packet for which the second fragmentation has been performed; and
transmitting the packet with the header added thereto through the physical layer.

9. The transmission packet processing method of claim 8, wherein the encrypting of the received packet comprises performing encryption using an IPSec.

10. A reception packet processing method, which is performed in a packet processing apparatus, comprising:
receiving a packet from a physical layer;
removing a header of the received packet;
when the packet from which the header has been removed is a packet for which a first fragmentation has been performed, reassembling the packet for which the first fragmentation has been performed;
decrypting the reassembled packet;
when a second fragmentation is necessary for the decrypted packet, performing the second fragmentation for the decrypted packet; and
transmitting the packet, for which the second fragmentation has been performed, to a network layer.

11. The reception packet processing method of claim 10, wherein the receiving of a packet comprises receiving the packet through a tunnel connected between networks.

12. The reception packet processing method of claim 11, wherein the removing of a header comprises decapsulating the packet received through the tunnel.

13. The reception packet processing method of claim 10, wherein the reassembling of the packet comprises:
storing the packet, for which the first fragmentation has been performed, in a queue; and
when all of packets for which first fragmentation has been performed are stored in the queue, reassembling the packets for which the first fragmentation has been performed.

14. The reception packet processing method of claim 10, wherein the decrypting of the reassembled packet comprises performing decryption using an IPSec.

15. The reception packet processing method of claim 10, further comprising when the second fragmentation is not necessary for the decrypted packet, transmitting the decrypted packet to the network layer.

16. The reception packet processing method of claim 10, wherein the network layer is an IP layer.

17. The reception packet processing method of claim 10, further comprising:
when the packet from which the header has been removed is not the packet for which the first fragmentation has been performed, decrypting the packet from which the header has been removed;
when the second fragmentation is necessary for the decrypted packet, performing the second fragmentation for the decrypted packet; and
transmitting the packet, for which the second fragmentation has been performed, to the network layer.

18. The reception packet processing method of claim 17, wherein the decrypting of the packet from which the header has been removed comprises performing decryption using an IPSec.
